(19) United States
(12) Patent Application Publication
(10) Pub. No.: US 2004/0015939 A1
(43) Pub. Date: Jan. 22, 2004

(54) Updateable memory module

(76) Inventors: Jonathon Y. Cheah, Southlake, TX (US); Zhiping Hu, San Diego, CA (US)

Correspondence Address: SIDLEY AUSTIN BROWN & WOOD LLP, 717 NORTH HARWOOD, SUITE 3400, DALLAS, TX, 75201, US

(21) Appl. No.: 09/858,396

(22) Filed: May 16, 2001

(51) Int. Cl. G06F 9/44; G06F 12/00

(52) U.S. Cl. 717/168; 711/100

(57) ABSTRACT

A memory module is provided using read only memory, nonvolatile reprogrammable memory, and random access memory. Initially, data is stored in the mask ROM. Updates to the data, including software or data updates or corrections, are stored in the nonvolatile reprogrammable memory. Locations of the data and the updated data are stored in the random access memory. To read the data, a controller first reads the random access memory to determine the location of the desired data and then reads the data from the location specified in the random access memory. The memory module can be used in consumer electronics, in which minor software updates are historically required, or where product enhancements can be easily implemented using revised software code or data.

### FIELD OF THE INVENTION

The present invention relates to an updateable memory module for use in products such as consumer electronics. In particular, the present invention provides a method of using low cost, mask read only memory in conjunction with a nonvolatile reprogrammable memory for storing software corrections and updates.

### BACKGROUND OF THE INVENTION

Consumer electronic products, especially high volume products, are produced under very tight schedules, frequently with fixed product launch dates. Given the significant lead time required for the production of a preferred lower cost, mask read only memory (ROM), the software within the product must be finalized several months in advance of the launch date. Frequently this deadline is not met, leading to software defects in the initial lot of products produced. Because the initial lot of products can be critical to the acceptance of the product in the marketplace, these software defects may lead to poor market reception of the new product. Alternatively, finalization of the product with complete debugging, followed by the long lead time required for production of mask ROMs, may lead to missed market opportunities. Thus, a manufacturer must carefully consider product launch dates in light of possible adverse publicity and product recalls that may result if the initial products prove to have software defects.

Additionally, consumer electronics can frequently be updated by providing improved software code for operating the devices. These performance enhancements may use most of the original code and require only relatively minor additions or changes. Because each update can require a new mask ROM, however, product enhancements must be carefully considered, with a substantial level of performance improvement being required to justify the cost of producing a new mask ROM.

This problem has been addressed in U.S. Pat. No. 5,940,074 to Britt, Jr. et al. (“Britt”), U.S. Pat. No. 5,901,330 to Sun et al. (“Sun”), and U.S. Pat. No. 5,477,264 to Sarbadhikari et al. (“Sarbadhikari”). The Britt patent provides a web TV system that allows the browser software to be upgraded over a network. Replacement data, which is downloaded from the Internet and stored in flash memory, overrides the corresponding data in the mask ROM. The Sun patent provides an in-circuit programming architecture wherein portions of ICP code which are likely to change are stored in flash, while other portions, which are not likely to change, are stored in mask ROM. The Sarbadhikari patent discloses a digital camera that stores the captured images in a removable memory card that is also preloaded with enhancement files for effecting the the operation of the system. Firmware algorithms determine whether the card contains the enhancement files and, if so, downloads the enhancement files to RAM to be used by the processor. These patents, however, do not fully resolve the problem discussed above.

Therefore, two needs exist to enhance the software used in consumer electronic products. The first need is for an apparatus and method that will allow software defects to be resolved prior to product introduction without the long lead time currently required to produce a mask ROM. The second need is for an apparatus and method to allow simple and timely upgrades to software code, thereby allowing product enhancement to be effected without requiring the replacement of an expensive component of the product.

### SUMMARY OF THE INVENTION

In one embodiment of the present invention, the memory module comprises a random access memory (RAM), a nonvolatile reprogrammable memory, a read only memory (ROM) and a controller. The controller controls the flow of data from the nonvolatile reprogrammable memory and the ROM to an electronic device. When the controller receives a request for data from the electronic device, the controller reads the RAM to determine the location of the requested data. If the requested data is located in the nonvolatile reprogrammable memory, the controller reads the requested data from the nonvolatile reprogrammable memory and provides the data to the electronic device since the data in the nonvolatile reprogrammable memory is updated data corresponding to the data located in the ROM. If the requested data is not located in the nonvolatile reprogrammable memory, the controller reads the ROM and provides the data to the electronic device.

In another embodiment of the present invention, the ROM and the nonvolatile reprogrammable memory contain a plurality of versions of software or data. The RAM contains a designation of the desired version and its location. When the controller receives a request for data, the controller reads the RAM to determine the desired version and then reads the desired version from either the ROM or the nonvolatile reprogrammable memory.

In yet another embodiment, the ROM contains a first set of software modules and the nonvolatile reprogrammable memory contains a second set of software modules. The RAM contains location information corresponding to the first and second sets of software modules, along with a sequence of execution of selected ones of the modules. The controller reads the RAM to determine the sequence of execution of the modules and then reads the selected modules from either the ROM or the nonvolatile reprogrammable memory.

Another embodiment of the present invention is a memory module comprising first and second memory subsystems. The first memory subsystem includes a mask ROM for storing fixed data, a RAM for storing a location of the fixed data, and a first microprocessor for controlling access to the memory module. The second memory subsystem includes a nonvolatile reprogrammable memory for storing updated data and a second microprocessor for controlling a flow of the updated data to and from the second memory subsystem.

When data is desired, the first microprocessor reads the RAM to determine the location of the desired data. If the desired data is located in the nonvolatile reprogrammable memory, the first microprocessor communicates with the second microprocessor to retrieve the data from the nonvolatile reprogrammable memory. If the desired data is not located in the nonvolatile reprogrammable memory, the first microprocessor reads the ROM to obtain the data.

Yet another embodiment of the present invention is a communication system including a communication subsystem and a base subsystem. The communication subsystem includes a RAM for storing updated data information, a mask ROM for storing fixed data, a communications microprocessor for controlling the flow of fixed data from the mask ROM, a display for displaying fixed data and/or updated data, and a data entry device for modifying the displayed data. The base subsystem includes a flash memory for storing updated data and a base microprocessor for controlling the flow of the updated data from the flash memory. The base microprocessor stores the modified data in the flash memory as updated data. The microprocessors process fixed data when the required data exists only in the mask ROM. However, when the random access memory indicates the required data exists in the flash memory, the microprocessors process updated data from the flash memory as the data in the flash memory corresponds to updated data.

### BRIEF DESCRIPTION OF THE DRAWINGS

The present invention is described in reference to the following Detailed Description and the drawings in which:

FIG. 1 is a block diagram of an embodiment of the present invention;

FIG. 2 is flowchart illustrating an operation of the embodiment illustrated in FIG. 1;

FIG. 3 is a block diagram of another embodiment of the present invention; and

FIG. 4 is a block diagram of a communication system according to the present invention.

### DETAILED DESCRIPTION OF THE PREFERRED EMBODIMENTS

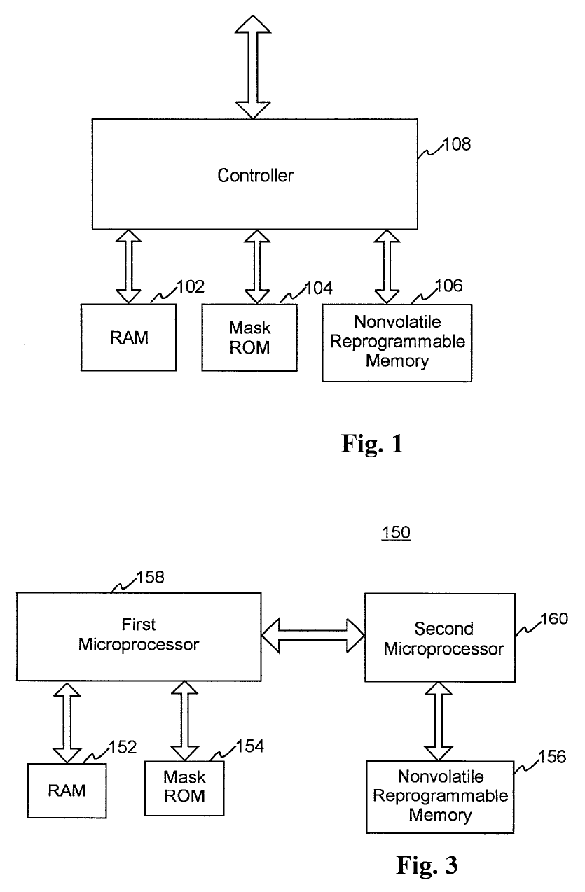

Various embodiments of the present invention are described in detail with reference to the drawings. FIG. 1 is a block diagram of a first embodiment of the present invention, a memory module 100 that allows stored data to be readily updated at minimal cost and with minimal production slowdown.

The memory module 100 includes four major components: a random access memory (RAM) 102, a mask read only memory (ROM) 104, a nonvolatile reprogrammable memory 106, and a controller 108. The nonvolatile reprogrammable memory 106 may be a flash memory or an electrically erasable programmable read-only memory (EEPROM). Flash memory may be preferable to EEPROM in many applications due to the relative ease (as compared to EEPROM) in which the flash memory can be erased and reprogrammed.

In the first embodiment, the mask ROM 104 contains fixed data. The fixed data may include software that was finalized well in advance of the completion of the electronic device (not shown) that incorporates the memory module 100. Since a long lead time may be required for production of the mask ROM 104, the software stored in the mask ROM 104 may not have been fully tested with the final device and, therefore, may be subject to errors. As errors are discovered during testing, the software is updated, with the updated portions being stored in the nonvolatile reprogrammable memory 106. The nonvolatile reprogrammable memory 106 is also provided with a map containing locations of the various portions of the software that was updated, along with the locations of the corresponding superceded versions of the software that is in the mask ROM 104. The map can then be copied to the RAM 102 as part of the power up process.

When the electronic device requests data, such as a particular portion of software or a software module, the controller 108 first reads the map in the RAM 102 to determine a location of the requested data. If the RAM 102 indicates that the requested data exists in the nonvolatile reprogrammable memory 106, this data will be read from the nonvolatile reprogrammable memory 106 and provided to the electronic device since it is the most recent version of the data (e.g., an updated version of the software module that was created after extensive testing of the device) and, therefore, supercedes the version of the data that is in the mask ROM 104, which was created prior to finalization of the electronic device. If, however, the RAM 102 indicates that the requested data does not exist in the nonvolatile reprogrammable memory 106, the controller 108 reads the requested data from the mask ROM 104 and provides the data to the electronic device. Since a corresponding version of the requested data was not found in the nonvolatile reprogrammable memory 106, the controller 108 can correctly assume that the requested data has not been updated.

The memory module 100 can receive updated data by several different methods. As discussed, the nonvolatile reprogrammable memory 106 can receive updated data, such as revised software modules, when the electronic device incorporating the memory module 100 is manufactured. The RAM 102 is accordingly updated to reflect that certain data that was stored in the mask ROM 104 has been superceded by the updated data stored in the nonvolatile reprogrammable memory 106.

The user of the electronic device incorporating the memory module 100 can also update the data. In this method, the electronic device typically includes a display to show instructions for modifying the data, and for displaying the data to be modified. The data displayed may be the fixed data stored in the mask ROM 104 or the updated data stored in the nonvolatile reprogrammable memory 106. The electronic device also typically includes a data entry device, such as a keypad or keyboard. The user can use the data entry device to enter new data or modify the existing data, and then indicate acceptance of the data. If the existing data is modified, or new data is provided, the data is stored in the nonvolatile reprogrammable memory 106 as updated data. The map in the RAM 102 will accordingly be updated with location information for the updated data.

Alternatively, the electronic device need not include the display or the data entry device, but can receive data from another device via a data link. For example, the user can connect the electronic device to a computer or another electronic device via the data link, which may be a serial, parallel, universal serial bus (USB), or wireless port. The user can then modify the data by using the data entry device and data display device associated with the computer.

Depending upon the sophistication of the electronic device, the memory module 100 may incorporate the latest data available at the time of manufacturing, with updated data being stored in the nonvolatile reprogrammable memory 106. The user, upon purchasing the electronic device, can further update the data as necessary.

The RAM 102 can be either volatile or nonvolatile. If the RAM 102 is volatile, the map in the RAM 102, which contains location information of the updated data and the corresponding fixed data, is also stored in the nonvolatile reprogrammable memory 106 to be available when power is removed from the electronic device. The electronic device can then include an initialization sequence to read the map from the nonvolatile reprogrammable memory 106 and to update the RAM 102 by placing a copy of the map in the RAM 102.

Alternatively, the RAM 102 may be initialized by a reading of the updated data found in the nonvolatile reprogrammable memory 106. The updated data can identify the corresponding fixed data in the mask ROM 104 that it supercedes. The RAM 102 can thus generate a map of the respective locations of the updated data in the nonvolatile reprogrammable memory 106. Of course, the RAM 102 can be nonvolatile RAM, thus eliminating the need to initialize the RAM 102 upon power up of the electronic device.

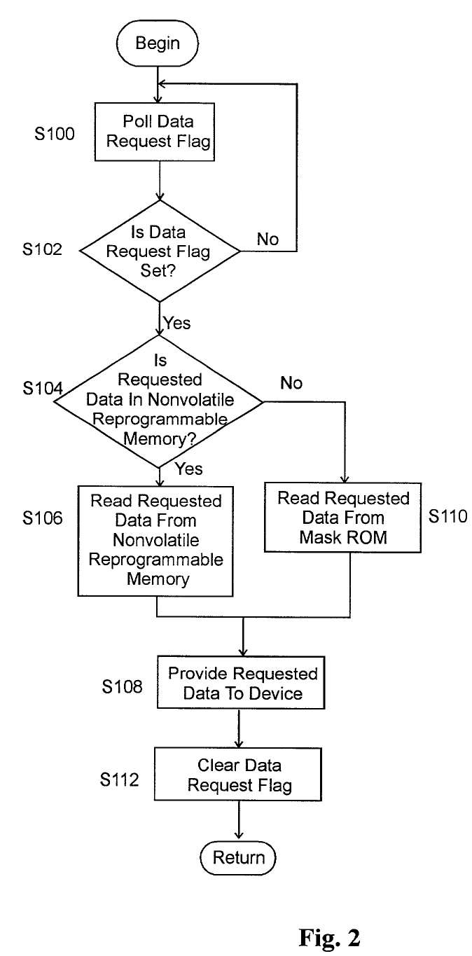

FIG. 2 is a flowchart diagram for the operation of the first embodiment in which the RAM 102 is static RAM. Static RAM is preferred since it is capable of providing faster access to the data. Of course, the RAM 102 can be dynamic RAM, which is lower cost and may preferable in cost sensitive electronic devices.

The controller 108 polls a data request flag in step S100. When the data request flag is set (S102:Yes) the electronic device is requesting data and the controller 108 reads the RAM 102 in step S104 to determine if the data exists in the nonvolatile reprogrammable memory 106. If the data request flag is not set in step 102 (S102:No) the controller 108 continues to poll the data request flag in step S100 until the data request flag is set (S102:Yes). If the RAM 102 indicates to the controller 108 that the requested data is in the nonvolatile reprogrammable memory 106 (S104:Yes) then the controller 108 reads this requested data from the nonvolatile reprogrammable memory 106 in step S106, and provides the requested data to the electronic device in step S108. If the RAM 102 indicates to the controller 108 that the requested data is not in the nonvolatile reprogrammable memory 106 (S104:No) then the controller 108 reads the requested data from the mask ROM 104 in step S110 and provides the requested data to the electronic device in step S108. The data request flag is then cleared in step S112 and control returns to the electronic device.

In a second embodiment of the present invention, also described with respect to FIG. 1, the mask ROM 104 contains fixed data corresponding to at least one version of software. The nonvolatile reprogrammable memory 106 contains alternative versions of the software, which may be used to replace the version(s) stored in the mask ROM 104. The RAM 102 contains a map, which lists the desired version(s) and their respective locations in the mask ROM 104 or in the nonvolatile reprogrammable memory 106.

As the electronic device incorporating the memory module 100 requires data, the controller 108 reads the map in the RAM 102 to determine, from the alternative versions that are available, the desired version and its location. The controller 108 can then read the desired version from either the mask ROM 104 or the nonvolatile reprogrammable memory 106 based on the location information stored in the RAM 102 and provide the desired version to the electronic device.

In a third embodiment of the present invention, also described with respect to FIG. 1, the mask ROM 104 contains data corresponding to a first set of software modules. The nonvolatile reprogrammable memory 106 contains a second set of software modules. Some of the modules in the second set may be alternative or replacement versions of the modules in the first set due to, for example, an error in the original version. Others of the modules in the second set may be new modules that were developed after the first set was finalized and therefore may not correspond to the modules in the first set. The RAM 102 contains a map, which lists location information corresponding to the modules in the first and second sets. The map also includes a sequence of execution of the modules in the first and second sets. By modifying the sequence of execution stored in the RAM 102, the desired modules can be marked for execution or disabled as desired.

Again, if the RAM 102 is volatile, the map is also stored in the nonvolatile reprogrammable memory 106, such that it is not lost when power is removed from the electronic device. The electronic device can include an initialization sequence to read the map from the nonvolatile reprogrammable memory 106 to determine the respective locations of the alternative versions. The RAM 102 can then be updated by copying the map from the nonvolatile reprogrammable memory 106 to the RAM 102. The initialization sequence can be provided as an embedded module in the ROM 104. Upon power up of the electronic device, the controller 108 executes the software in the embedded module, thus starting the initialization sequence.

Selection of a desired version of data or whether a particular module is to be executed or disabled can be made before the electronic device is sold to the user. Thereafter, different versions of the data or different execution sequences of the software modules, which were stored in the mask ROM 104 or the nonvolatile reprogrammable memory 106 during manufacture of the electronic device, can be selected. For example, although electronic devices are generally manufactured in accordance with specifications promulgated by standards bodies, some of the features envisioned by the specifications may not be currently implemented, and thus are not available for use. In prior art devices, such features are not incorporated into the software of the device. Thus, as new features that were envisioned by the specifications become available, the user of the device will discover that the device does not possess software that is capable of accessing or performing these features. The user must therefore return the device to the manufacturer for replacement of the software or, alternatively, purchase a new device containing updated software.

In the electronic device according to the present invention, however, features that are not yet available can be included in an alternative version of the software or as an alternative software module. Then, as support for these features becomes available, the features may be easily activated by selection of the appropriate versions of the software or the appropriate software modules. The user thus is not required to return the device to the manufacturer for updating of its software, as would be required with the prior art devices.

Selection of the desired software version or module can be made by the user, via a data entry device, such as the keypad or keyboard. Alternatively, if the electronic device is a wireless device, such as a wireless telephone, selection of the desired version may be made by a wireless base station to which the wireless telephone is connected. Thus, the device may operate with a correct version of data, or a particular sequence of execution of software modules, based on the features that are supported by the service provider at any particular time.

Implementation of the first, second and third embodiments requires an amount of mask ROM that is determined according to the particular electronic device. The amount of RAM and nonvolatile reprogrammable memory to be included is determined by several factors. In cost sensitive electronic devices, a minimal amount of RAM and nonvolatile reprogrammable memory will be included to keep manufacturing costs low. In more complex electronic devices that have historically required significant software revision, an amount of RAM and nonvolatile reprogrammable memory corresponding to a fixed percentage of the mask ROM may be preferable. Additionally, electronic devices that have the potential of achieving significantly increased performance based on revised software programs may include a larger amount of RAM and nonvolatile reprogrammable memory in an effort to extend the life of the device. In a production line, a given mask ROM may be used for an extended period of time. The nonvolatile reprogrammable memory (and RAM), however, are programmed at the time of manufacture and can therefore incorporate any software patches or product enhancements in effect at that time.

A memory module 150 in accordance with a fourth embodiment of the present invention is illustrated in FIG. 3. The memory module 150 includes a RAM 152, a mask ROM 154 for storing fixed data and a nonvolatile reprogrammable memory 156 for storing updated data. The memory module 150 further includes a first microprocessor 158 and a second microprocessor 160. The first microprocessor 158 is a primary microprocessor 158 for an electronic device incorporating the memory module 150. The second microprocessor 160 is used to control the flow of updated data to and from the nonvolatile reprogrammable memory 156.

Since long lead times are generally required to produce the mask ROM 154, the mask ROM 154 typically includes software that was developed prior to completion of the electronic device. Further, at the time the mask ROM 154 was developed, certain features that are desirable to have in the electronic device may not have been supported due to, for example, lack of infrastructure to support the features. Since such features are known prior to production of the mask ROM 154, the present invention advantageously incorporates those features into the software, but in alternative versions. Thus the mask ROM 154 can include all software and features that are known at the time that the mask ROM 154 is being produced.

Then, as the electronic device nears completion, software updates or corrections can be programmed into the nonvolatile reprogrammable memory 156. Further features that are known at this time may also be programmed into the nonvolatile reprogrammable memory 156. The RAM 152 can be programmed to allow access to the latest corrected versions of the software. Additionally, features that were included in alternative versions in the mask ROM 154 that are now supported can also be enabled in the RAM 152. Thus, when the user purchases the electronic device, all known software corrections and supported features may be made available to the user. Further, as more features, which were preprogrammed in either the mask ROM 154 or the nonvolatile reprogrammable memory 156, become available, the RAM 152 can be updated to also allow access to those features.

The operation of the memory module 150 will now be described. The first microprocessor 158 requests data by first accessing the RAM 152 to determine a desired version of the data, along with the location of the desired version. If the desired data is determined to be in the nonvolatile reprogrammable memory 156, the first microprocessor 158 requests the data from the second microprocessor 160. The second microprocessor 160 in turn reads the data from the nonvolatile reprogrammable memory 156 and provides the requested data to the first microprocessor 158. If the requested data is determined to be in the mask ROM 154, the first microprocessor 158 reads the data from the mask ROM 154.

In this embodiment, virtually all processing is done in the first microprocessor 158, while the second microprocessor 160 is only required to control the flow of data from the nonvolatile reprogrammable memory 156. Thus, the second microprocessor 160 may be an earlier generation microprocessor (or microcontroller) than the first microprocessor. As with the first, second and third embodiments, the fourth embodiment is designed with RAM, mask ROM, and nonvolatile reprogrammable memory based upon cost and performance requirements.

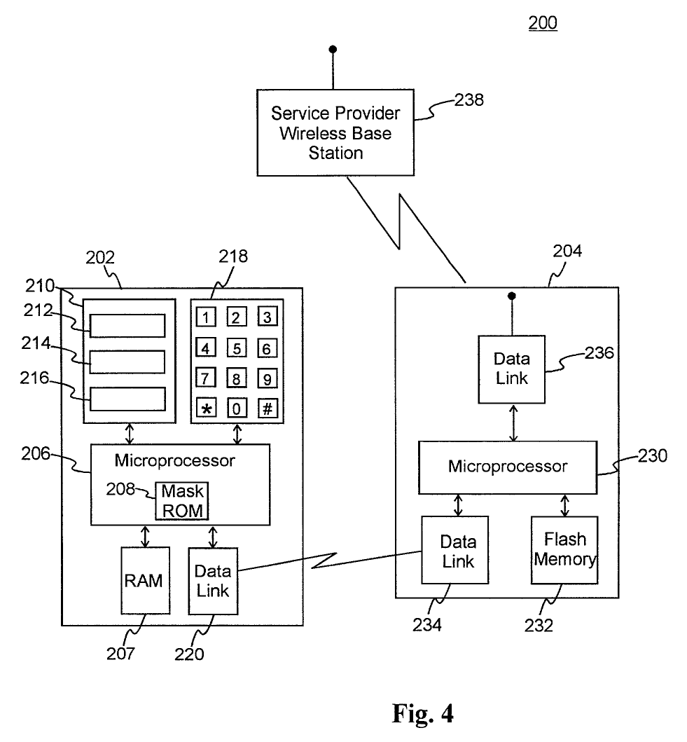

A fifth embodiment of the present invention is a communication system 200 utilizing the fourth embodiment of the present invention. The communication system 200 includes a communication subsystem 202 and a base subsystem 204, as shown in FIG. 4. The communication subsystem 202 includes a communications microprocessor 206, a RAM 207, a mask ROM 208, a display 210, a keypad 218, and a communication subsystem data link 220 for communicating with the base subsystem 204. The communications microprocessor 230 operates the communication subsystem 202 using the data stored in the RAM 207 and the mask ROM 208. The mask ROM 208 is preferably an integral part of the communications microprocessor 206, but can also be a separate component.

The base subsystem 204 includes a base microprocessor 230, a flash memory 232, a first data link 234 for communicating with the communication subsystem 202, and a second data link 236 for communicating with a communications service provider. The base microprocessor 230 is connected to and controls the flash memory 232 and both the first and second data links 234, 236. The base microprocessor 230 is responsible for controlling the flow of updated data to and from the flash memory 232. While this embodiment uses a flash memory 232, other nonvolatile reprogrammable memory devices can also be used.

Since the updated data is stored in the flash memory 232 in the base subsystem, systems wherein the RAM 207 is volatile will preferably include an embedded module in the mask ROM 208 that initializes the RAM 207 upon power up. The communication microprocessor 206 executes the software stored in the embedded module to initialize the RAM 207 with location data pertaining to the updated data in the flash memory 232.

The data link 220 of the communication subsystem 202 and the first data link 234 of the base subsystem 204 communicate using a communication protocol that is adequate to ensure efficient and accurate transmission of data between the communication subsystem 202 and the base subsystem 204. The data link 220 and the first data link 234 can be conventional wireless links such as those used in conventional wireless devices such as cordless telephones. Alternatively, the data link 220 and the first data link 234 can employ more robust protocols such as the digital enhanced cordless telecommunications (DECT) protocol or other wireless communications protocols.

In a preferred embodiment, the communication system 200 is a wireless local loop cordless telephone, such as a wireless telephone designed for use within a fixed location. In such an embodiment, the communication subsystem 202 is a cordless handset of the wireless telephone and the base subsystem 204 is a base unit of the wireless telephone. The communication system 200 uses the second data link 236 in the base subsystem 204 to communicate with a wireless base station 238 associated with the service provider. In a preferred embodiment, the communication system 200 communicates with the base station 238 via a code-division multiple access (CDMA) protocol. The CDMA protocol is preferred due to its use of spread spectrum technology, which is highly resistant to cloning, and its compatibility with other cellular technologies, which allows for nationwide use.

The communications microprocessor 206 operates using data stored in the RAM 207, fixed data from the mask ROM 208, and updated data from the flash memory 232 The communications subsystem uses the display 210 and keypad 218 to provide an interface to the user. The display 210 has a screen capable of displaying at least one line, but preferably more lines to allow more detailed information to be displayed. In this embodiment, the display 210 has three lines: the first display line 212 displays a main instruction, while the second and third display lines 214, 216 display fields of data that can be modified or accepted in accordance with the main instruction. The second and third lines 214, 216 can also display further instructions to the user as necessary.

The keypad 218 is used in conjunction with the display 210 to retrieve fixed data from the mask ROM 208 or updated data from the flash memory 232. To retrieve fixed data from the mask ROM 208, the communication microprocessor 208 reads the mask ROM 208 and provides the data to the display 210. If updated data is required, the communication microprocessor 208 uses the communication subsystem data link 220 to request the required data from the base subsystem 204. In response to the request from the communication microprocessor 208, the base microprocessor 230 retrieves the requested data from the flash memory 232 and provides the data to the first data link 234, which then transmits the data to the communication subsystem data link 220 of the communication subsystem 202. The communication microprocessor 208 can then provide the requested data to the display 210.

Once the data has been retrieved and displayed, the user can choose to leave the data unchanged, or to modify the data. If the data is modified, in communication microprocessor 206 will preferably ask the user to accept or confirm the modification. Once the modification has been accepted, the modified data is sent to the base subsystem 204 via the communication subsystem data link 220 and the first data link 234. The base microprocessor 230 receives the modified data and stores the modified data into a location in the flash memory 232 as updated data. Additionally, the communication microprocessor 206 stores the location of the modified data in the RAM 207. In one embodiment, the base microprocessor 208 informs the communication microprocessor 206 of the actual address of the updated data in the flash memory 232. Alternatively, the communication microprocessor 206 need only store location data sufficient to allow the communication microprocessor 206 to request the updated data from the base microprocessor 230.

The communication system 200 communicates with the base station 238 via the second data link 236 in the base subsystem 204. In the preferred embodiment, the second data link 236 is a CDMA module for communicating with the base station 238 via the CDMA protocol. The base station 238 routes calls to and from the communication system 200. The base station 238 can also provide updated information or software to the communication system 200.

For example, while the CDMA specification allows for full speed IS-707 data services, only a very small subset of the services are currently available. Thus, conventional wireless telephones or other communications devices based on the CDMA specification are only equipped with the software that is necessary to handle the subset of services that are available. As new services become available, the conventional devices are not able to access the new services. For example, a service provider may begin supporting data connectivity of the type that enables a customer to connect his laptop computer through his wireless telephone. The customer signs up for the service, only to discover that his conventional wireless telephone does not have the software necessary to support the service.

The communication system 200 of the present invention, however, can be advantageously equipped with all the services contemplated by the CDMA specification (or other relevant communications specifications). Software modules for services that are not currently available can reside on the mask ROM 208 or the flash memory 232 but are dynamically disabled by data stored in the RAM 207. Then, as certain services become available from the service provider, the customer can sign up for the service. The service provider can activate the portions of the software necessary to support the new service by transmitting the appropriate instructions from the base station 238 to the communication device 200.

The base subsystem 204 can receive updated data from the base station 238 via the second data link 204. The updated data, which contains information for activating certain software modules that are necessary to support the new service, is stored in the flash memory 232. A portion of the updated data, which includes information for dynamically selecting certain software modules, is transmitted to the communication subsystem 202 via the first data link 234. The communication subsystem 202 receives the updated data and stores it in the RAM 207. The communication microprocessor 207 can optionally display information on the display 210 to indicate to the user that the new functionality is available, giving the user the option to accept or reject the new functionality.

During operation of the communication system 200, selected software modules, which were previously stored in the mask ROM 208, flash memory 232, or RAM 207 when the communication system 200 was manufactured, can be dynamically selected by the updated data stored in the RAM 207. Thus, the user is conveniently provided with a communication system 200 having “new” features, without being required to purchase a new communication system or returning his communication system to the manufacturer for a software upgrade.

As another example, a service provider may allow the user to activate the communication system 200 using “Over The Air Activation.” Different service providers, however, typically have different procedures for activation. Manufacturers are conventionally required to produce a number of different communication systems, each specifically tailored to the activation procedure required by a service provider. Since all the variations in activation procedures are known, the communication system 200 of the present invention can advantageously incorporate all the required activation procedures. Upon activation, the RAM 207 can then utilize the proper activation procedure for a specific service provider. Thus, the manufacturer can avoid having to produce a different communication system for each service provider, thereby lowering production and inventory costs.

The base station 238 can also provide the communication system 200 with additional or replacement software modules in the form of updated data. After shipping the communication device 200, the manufacturer may have discovered errors in one or more of the software modules, or may have developed a new software module to support a new feature that may not have been contemplated at the time the communication device 200 was manufactured. In either case, the updated data is received by the communication device 200 and stored in the flash memory 232, with a portion of the updated data (including at least location information) stored in the RAM 207.

Some service enhancements provided by the service provider may require user input. As an example, the service provider may start offering speed dialing as an option. If the user wishes to use this option, various speed dial telephone numbers can be entered. The base microprocessor 230 sends a speed dial number request menu to the communications subsystem 202 via the first data link 234. The communications subsystem 202 receives the speed dial number request menu via the communications data link 220. The speed dial number request menu is then displayed on the display 210. When the user enters a desired speed dial telephone number using the keypad 218, the communications subsystem 202 transmits the data, using the communications data link 220, to the base subsystem 204. The base subsystem 204 receives the speed dial telephone number via the first data link 234, and the base microprocessor 230 stores the speed dial telephone number in the flash memory 232. In addition, the communications microprocessor 206 stores data relating to the location of the speed dial telephone number in the RAM 207.

As more service enhancements, including software upgrades, are entered, the possibility exists that memory addresses, etc. may be duplicated. For this reason, the most recent data as determined by the RAM 207 and stored in the flash memory 232 is always used. This allows defects in the original software stored in the mask ROM 208 to be corrected by a first revision stored in the flash memory 232. If it is subsequently found that the first revision also has defects, a second revision can be stored in the flash memory 232 without worry of conflicting data, such as addresses, etc. In each case, the table in the RAM 207 is updated to reflect the revised location for the most current revision.

Although the present invention has been fully described by way of examples with reference to the accompanying drawings, it is to be noted that various changes and modifications will be apparent to those skilled in the art. Therefore, such changes and modifications should be construed as being within the scope of the invention.

What is claimed is:

1. A method for providing data to an electronic device, comprising the steps of:
reading a random access memory to determine a location of said data;
reading a nonvolatile reprogrammable memory, if said data is located in said nonvolatile reprogrammable memory;
reading a read only memory, if said data is not located in said nonvolatile reprogramable memory; and
providing said data to said electronic device;
wherein said nonvolatile reprogrammable memory contains updated data corresponding to fixed data contained in said read only memory, said data thus provided to said electronic device being most recent data.

2. A method as recited in claim 1, wherein said random access memory is nonvolatile.

3. A method as recited in claim 1, wherein said nonvolatile reprogrammable memory contains the respective locations of said fixed data and said corresponding updated data.

4. A method as recited in claim 3, wherein said random access memory is volatile, said method further comprising the steps of:
reading said nonvolatile reprogrammable memory to determine said respective locations; and
updating said random access memory with said respective locations.

5. A method as recited in claim 1, further comprising the steps of:
displaying at least one of said fixed data and said updated data so as to allow said at least one of said fixed data and said updated data thus displayed to be modified; and
storing the thus modified data in said nonvolatile reprogrammable memory as updated data.

6. A method as recited in claim 1, wherein said nonvolatile reprogrammable memory is selected from the group consisting of:
a flash memory; and
an electrically erasable programmable read-only memory.

7. A method for providing data to an electronic device, comprising the steps of:
reading a random access memory to select a desired version of said data from among a plurality of versions of said data stored in a nonvolatile reprogrammable memory and a read only memory;
reading said desired version from said nonvolatile reprogrammable memory or said read only memory in accordance with the selection; and
providing said desired version to said electronic device.

8. A method as recited in claim 7, wherein said random access memory is nonvolatile.

9. A method as recited in claim 7, wherein said nonvolatile reprogrammable memory contains respective locations of said plurality of versions.

10. A method as recited in claim 9, wherein said random access memory is volatile, said method further comprising the steps of:
reading said nonvolatile reprogrammable memory to determine said respective locations of said plurality of versions;
updating said random access memory with said respective locations of said plurality of versions.

11. A method as recited in claim 7, wherein said nonvolatile reprogrammable memory contains an indication of said desired version from among said plurality of versions.

12. A method as recited in claim 7, wherein said nonvolatile reprogrammable memory is selected from the group consisting of:
a flash memory; and
an electrically erasable programmable read-only memory.

13. A method for storing a software program in a memory module, comprising the steps of:
creating a read only memory containing a first set of software modules;
storing in a nonvolatile reprogrammable memory a second set of software modules, at least one module in said second set corresponding to a module in said first set;
storing in a random access memory location information corresponding to said modules in said first and second sets;
storing in said random access memory a sequence of execution of selected ones of said modules in said first and second sets.

14. A method as recited in claim 13, wherein said at least one module in said second set is an updated version of the corresponding module in said first set, said at least one module in said second set correcting an error in said corresponding module in said first set.

15. A method as recited in claim 13, wherein said random access memory is nonvolatile.

16. A method as recited in claim 13, wherein said random access memory is volatile, said method further comprising the step of storing said sequence of execution in said nonvolatile reprogrammable memory.

17. A method as recited in claim 16, further comprising the step of initializing said random access memory by copying said sequence of execution from said nonvolatile reprogrammable memory to said random access memory.

18. A method as recited in claim 13, wherein said nonvolatile reprogrammable memory is selected from the group consisting of:
a flash memory; and
an electrically erasable programmable read-only memory.

19. A memory module, comprising:
a read only memory for storing fixed data;
a nonvolatile reprogrammable memory for storing updated data corresponding to said fixed data;
a random access memory for storing location data corresponding to said updated data; and
a controller for controlling access to said memory module by use of said location data, said controller adapted to provide said updated data if said updated data is available, and to provide said fixed data if said updated data is not available.

20. A memory module as recited in claim 19, wherein said random access memory is nonvolatile.

21. A memory module as recited in claim 19, wherein said random access memory is volatile, said controller adapted to initialize said random access memory with said location data of said updated data stored in said nonvolatile reprogrammable memory.

22. A memory module as recited in claim 19, wherein said fixed data and said updated data are adapted to be displayed on a display associated with said memory module.

23. A memory module as recited in claim 22, wherein at least one of said fixed data and said updated data thus displayed may be modified via a data entry device associated with said memory module, the thus modified data being stored in said nonvolatile reprogrammable memory as updated data.

24. A method as recited in claim 19, wherein said nonvolatile reprogrammable memory is selected from the group consisting of:
a flash memory, and
an electrically erasable programmable read-only memory.

25. A memory module, comprising:
a read only memory;
a nonvolatile reprogrammable memory;
a random access memory for storing location data corresponding to a desired version of data from among a plurality of versions of said data stored in said nonvolatile reprogrammable memory and said read only memory; and
a controller for controlling access to said memory module by use of said location data, said controller adapted to provide said desired version from said nonvolatile reprogrammable memory or said read only memory.

26. A memory module as recited in claim 25, wherein said random access memory is nonvolatile.

27. A memory module as recited in claim 25, wherein said nonvolatile reprogrammable memory contains respective locations of said plurality of versions.

28. A memory module as recited in claim 27, wherein said random access memory is volatile, said controller adapted to initialize said random access memory with said respective locations of said plurality of versions stored in said nonvolatile reprogrammable memory.

29. A memory module as recited in claim 25, wherein said nonvolatile reprogrammable memory is selected from the group consisting of:
a flash memory; and
an electrically erasable programmable read-only memory.

30. A memory module, comprising:
a first memory subsystem, including:
a mask read only memory for storing fixed data;
a random access memory for storing a location of said fixed data; and
a first microprocessor for controlling access to said memory module;
a second memory subsystem, including:
a nonvolatile reprogrammable memory for storing updated data, wherein a location of said updated data is stored in said random access memory; and
a second microprocessor for controlling a flow of said updated data to and from said nonvolatile reprogrammable memory;
wherein said first microprocessor is adapted to read said random access memory to determine a location of a desired one of said fixed and updated data, said first microprocessor being adapted to communicate with said second microprocessor to receive said updated data therefrom if the desired data is said updated data and to read said mask read only memory if said desired data is said fixed data.

31. A memory module as recited in claim 30, wherein at least one of said updated data corresponds to one of said fixed data, said updated data being an updated version of said fixed data.

32. A memory module as recited in claim 30, wherein said fixed and updated data are adapted to be displayed on a display associated with said memory module.

33. A memory module as recited in claim 32, wherein at least one of said fixed and updated data thus displayed may be modified via a data entry device associated with said memory module, the thus modified data being stored in said nonvolatile reprogrammable memory by said second microprocessor.

34. A memory module as recited in claim 33, wherein said data entry device is selected from the group consisting of:
a keypad; and
a keyboard.

35. A memory module as recited in claim 30, wherein said nonvolatile reprogrammable memory is selected from the group consisting of:
a flash memory; and
an electrically erasable programmable read-only memory.

36. A communication system, comprising:
a base subsystem, including:
a nonvolatile reprogrammable memory for storing updated data;
a base microprocessor for controlling a flow of said updated data to and from said nonvolatile reprogrammable memory;
a communication subsystem, including:
a mask read only memory for storing fixed data;
a random access memory for storing locations of said fixed and updated data;
a communications microprocessor for processing said fixed and updated data;
a display for displaying at least one of said fixed and updated data;
a data entry device for modifying said at least one of said fixed and updated data thus displayed; and
a data link for transporting said updated data between said communication subsystem and said base subsystem;
wherein said communications microprocessor is adapted to read said random access memory to determine a location of a desired one of said fixed and updated data, said communications microprocessor being adapted to communicate with said base microprocessor via said data link to receive said updated data if the desired data is said updated data and to read said mask read only memory if said desired data is said fixed data.

37. A communication system as recited in claim 36, wherein said base subsystem further comprises a second data link for communicating with a communications service provider.

38. A communication system as recited in claim 37, wherein said communications service provider is adapted to communicate with said base microprocessor via said second data link to provide said updated data to said nonvolatile reprogrammable memory.

39. A wireless telephone, comprising:
a base unit, including:
a nonvolatile reprogrammable memory for storing updated data;
a base microprocessor for controlling a flow of said updated data to and from said nonvolatile reprogrammable memory;
a wireless module for communicating with a wireless base station;
a cordless handset, including:
a mask read only memory for storing fixed data;
a random access memory for storing locations of said fixed and updated data;
a communications microprocessor for processing said fixed and updated data;
a cordless module for communicating with a corresponding cordless module of said base unit;
wherein said communications microprocessor is adapted to read said random access memory to determine a location of a desired one of said fixed and updated data, said communications microprocessor being adapted to communicate with said base microprocessor via said cordless module to receive said updated data if the desired data is said updated data and to read said mask read only memory if said desired data is said fixed data.

40. A wireless telephone as recited in claim 39, wherein a portion of said fixed or updated data corresponds to a calling feature not yet implemented by a service provider associated with said wireless telephone, said random access memory containing a sequence of execution that omits said portion.

41. A wireless telephone as recited in claim 40, wherein said portion of said fixed or updated data is included in said sequence once said calling feature is implemented by said service provider.
